(19) United States
(12) Patent Application Publication
(10) Pub. No.: US 2008/0068864 A1
(43) Pub. Date: Mar. 20, 2008

(54) BACKLIGHT MODULE

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 11/829,095

(22) Filed: Jul. 27, 2007

(30) Foreign Application Priority Data
Sep. 20, 2006 (CN) 200620200786.2

(51) Int. Cl. F21V 13/04

(52) U.S. Cl. 362/625; 362/624

(57) ABSTRACT

A backlight module includes a light source and a light guide plate. The light guide plate has a side surface adjacent the light source for entry of light beams from the light source, a bottom surface perpendicular to the side surface, a plurality of identical protrusions formed on the bottom surface, and a reflecting film plated on the bottom surface and the plurality of identical protrusions. The identical protrusions diffuse the light from the light source out of an upper surface of the light guide plate, which is opposite to the bottom surface. The reflecting film reflects the light leaking from the bottom surface back to the light guide plate.

### BACKGROUND OF THE INVENTION

1. Field of the Invention

The present invention relates to backlight modules, and particularly to backlight modules for use in light display devices such as liquid crystal displays.

2. Description of Related Art

In a liquid crystal display device, liquid crystal is a substance that does not itself radiate light. Instead, the liquid crystal relies on receiving light from a light source, thereby displaying images and data. In the case of a typical liquid crystal display device, a backlight module powered by electricity supplies the needed light.

Backlight modules generally include edge-lighting type backlight modules and direct type backlight modules. Referring to FIG. 3, a conventional edge-lighting type backlight module includes a light source 100, a reflector 200, a light guide plate 300, a diffusion plate 400, and two brightness enhancement plates 500, 600. The light source 100 used in the backlight module can be a light emitting diode (LED), or a cold cathode fluorescent lamp (CCFL). The light guide plate 300 includes a base plate 310, and a plurality of identical protrusions 320 formed on a bottom surface of the base plate 310. The identical protrusions 320 diffuse the light beams from the light source 100 out of an upper surface of the base plate 310. The reflector 200, positioned below the light guide plate 300, includes a base plate 210 and a reflecting sheet 220 formed on the base plate 210. The reflector 200 reflects the light beams leaking from a bottom surface of the base plate 310 back to the light guide plate 300. The diffusion plate 400 is disposed on the light guide plate 300 to provide greater light uniformity. The brightness enhancement plates 500, 600 are disposed on the diffusion plate 400 sequentially to enhance brightness of the light. The base plates 210, 310 are made of acrylic material. The reflecting sheet 220 is made of aluminum material. However, the reflecting sheet 220 is a separate part that has to be attached to the bottom surface of the base plate 310 in assembly, which makes the assembly of the backlight module time-consuming. Moreover, attachment of the reflector 200 to the uneven bottom surface of the light guide plate 300 cannot be done without there being leakage of some light beams.

What is needed, therefore, is a backlight module with a timesaving assembly and less leakage of light.

### SUMMARY OF THE INVENTION

A backlight module with a timesaving assembly is provided. In a preferred embodiment, the backlight module includes a light source and a light guide plate. The light guide plate has a side surface adjacent the light source for entry of light beams from the light source, a bottom surface perpendicular to the side surface, a plurality of identical protrusions formed on the bottom surface, and a reflecting film plated on the bottom surface and the plurality of identical protrusions. The identical protrusions diffuse the light from the light source out of an upper surface of the light guide plate, which is opposite to the bottom surface. The reflecting film reflects the light leaking from the bottom surface back to the light guide plate.

Other advantages and novel features will become more apparent from the following detailed description when taken in conjunction with the accompanying drawings, in which:

### BRIEF DESCRIPTION OF THE DRAWINGS

FIG. 1 is a schematic, front view of a backlight module in accordance with a preferred embodiment of the present invention;

FIG. 2 is a schematic, front view of a light guide plate of FIG. 1; and

FIG. 3 is a schematic, front view of a conventional backlight module.

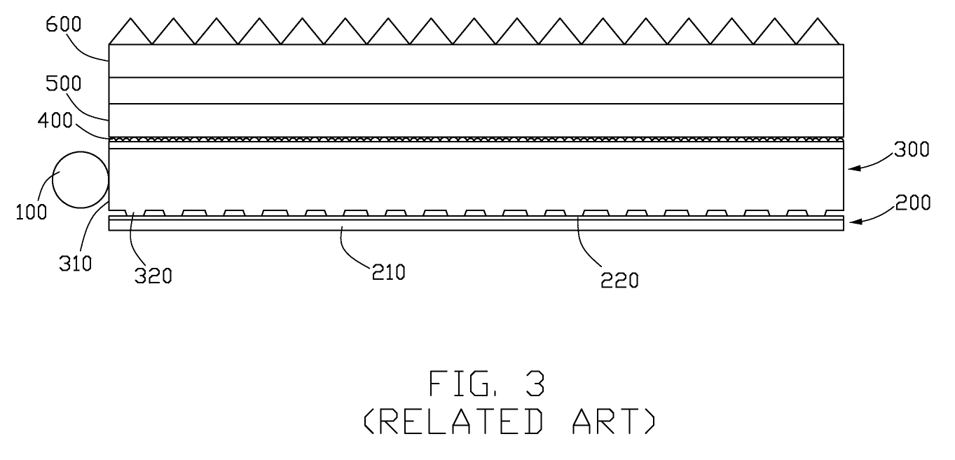

### DETAILED DESCRIPTION OF THE INVENTION

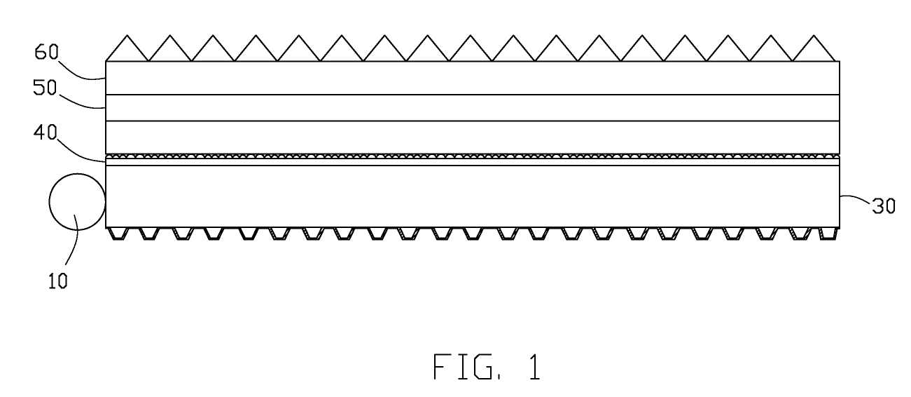

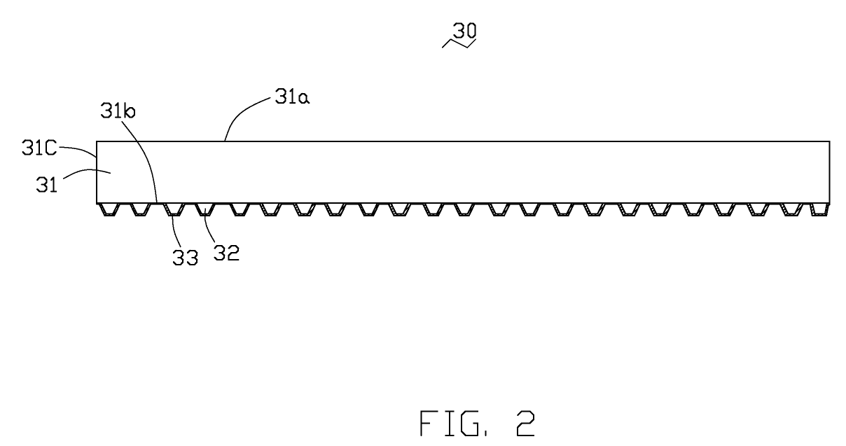

Referring to FIG. 1 and FIG. 2, a backlight module in accordance with a preferred embodiment of the present invention includes a light source 10, a light guide plate 30, a diffusion plate 40, and two brightness enhancement plates 50, 60. The light source 10 used in the backlight module can be a light emitting diode (LED), or a cold cathode fluorescent lamp (CCFL). The light source 10 is located adjacent to a side surface 31c of the light guide plate 30. The light guide plate 30 includes a base plate 31, a plurality of identical trapeziform-shaped protrusions 32 formed on a bottom surface 31b of the base plate 31, which is perpendicular to the side surface 31c, and a reflecting film 33 plated on the bottom surface 31b and all of the trapeziform-shaped external surfaces of the plurality of identical protrusions 32. The plurality of identical protrusions 32 diffuse the light beams from the light source 10 out of an upper surface 31a of the light guide plate 30, which is opposite to the bottom surface 31b. The reflecting film 33 reflects the light beams leaking from the bottom surface 31b back to the light guide plate 30. The diffusion plate 40 is disposed on the light guide plate 30 to enhance uniform distribution of the light beams. The brightness enhancement plates 50, 60 are disposed on the diffusion plate 40 sequentially to enhance brightness of the light beams. The base plate 31 is made of acrylic material. The reflecting film 33 is made of silver or aluminum material with good light reflecting characteristics.

The reflecting film 33 is directly plated on the bottom surface 31b and the plurality of identical protrusions 32 when the light guide plate 30 is manufactured. Therefore, the assembly of the backlight module is less time-consuming compared to the conventional art. Furthermore, the reflecting film 33 is tightly contacted with the bottom surface 31b and the identical protrusions 32, improving the utilization efficiency of the light beams leaking from the bottom surface 31b.

The embodiment was chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A backlight module configured to uniformly illuminate a liquid crystal panel, comprising:
a light source; and
a light guide plate having a side surface adjacent the light source for entry of light beams from the light source, a bottom surface perpendicular to the side surface, a plurality of identical protrusions formed on the bottom surface, and a reflecting film plated on the bottom surface and the plurality of identical protrusions, the identical protrusions diffusing the light beams from the light source out of an upper surface of the light guide plate, which is opposite to the bottom surface, the reflecting film reflecting the light beams leaking from the bottom surface back to the light guide plate.

2. The backlight module as claimed in claim 1, further comprising a diffusion plate disposed on the light guide plate, for enhancing uniform distribution of the light beams.

3. The backlight module as claimed in claim 2, further comprising a light brightness enhancement plate disposed on the diffusion plate.

4. The backlight module as claimed in claim 1, wherein the reflecting film is made of silver or aluminum material with good light reflecting characteristics.

5. A backlight module configured to uniformly illuminate a liquid crystal panel, comprising:
a light source;
a light guide plate having a first surface adjacent the light source for entry of light beams from the light source, a second surface perpendicular to the first surface, a plurality of identical protrusions formed on the second surface, and a reflecting film plated on the second surface and the plurality of identical protrusions, the identical protrusions diffusing the light from the light source out of a third surface of the light guide plate, which is opposite to the second surface, the reflecting film reflecting the light beams leaking from the second surface back to the light guide plate; and
a diffusion plate disposed on the light guide plate, for enhancing uniform distribution of the light beams.

6. The backlight module as claimed in claim 5, further comprising a light brightness enhancement plate disposed on the diffusion plate.

7. The backlight module as claimed in claim 5, wherein the reflecting film is made of silver or aluminum material with good light reflecting characteristics.

8. A backlight module configured to uniformly illuminate a liquid crystal panel, comprising:
a light source;
a light guide plate having a side surface adjacent the light source for entry of light beams from the light source, a bottom surface perpendicular to the side surface, and a top surface opposite to the bottom surface, a plurality of identical protrusions projecting downward from the bottom surface for diffusing the light beams from the light source out of the top surface, and;
a reflecting film plated on the bottom surface and an external surface of each of the identical protrusions configured to reflect the light beams leaking from the bottom surface back to the light guide plate.

9. The backlight module as claimed in claim 8, wherein the external surface of each of the protrusions is trapeziform-shaped, and the reflecting film comprises a plurality of trapeziform-shaped sections fittingly covering the external surfaces respectively.
